(19) United States
(12) Patent Application Publication
(10) Pub. No.: US 2023/0092535 A1
(43) Pub. Date: Mar. 23, 2023

(54) SYSTEMS AND METHODS FOR DIFFERENTIATED ORDER MODIFICATION BASED ON DEVICE AND/OR USER ATTRIBUTES

(71) Applicant: Verizon Patent and Licensing Inc., Basking Ridge, NJ (US)

(72) Inventor: Chinnangari Krishna Kishore Reddy, YSR Kadapa (IN)

(73) Assignee: Verizon Patent and Licensing Inc., Basking Ridge, NJ (US)

(21) Appl. No.: 17/478,383

(22) Filed: Sep. 17, 2021

(51) Int. Cl. G06Q 30/06; G06Q 10/08

(52) U.S. Cl. CPC G06Q 30/0635; G06Q 10/087

(57) ABSTRACT

A system described herein may generate and/or modify a model that correlates attributes of orders, users, and/or User Equipment (“UEs”) to order modification parameters. The order modification parameters may indicate whether to modify the position in an order queue of an order for which a modification has been received. One set of order modification parameters may indicate that a modified order should be placed in the same position in the order queue as an original order. Another set of order modification parameters may indicate that a modified order should be placed at the end of the order queue, and/or at some position between the end of the order queue and the position of the original order. UEs checking the status of the order may receive different options to modify or cancel the order, based on order modification parameters identified with respect to the order or the UE.

### BACKGROUND

Organizations, enterprises, institutions, etc. may offer fulfillment of orders, such as pre-orders for newly released (or soon to be released) goods, or orders for goods that are currently available. Some orders may be placed in a queue and/or may not otherwise be immediately fulfilled, such as in situations where an order is a pre-order for an item that has not yet been released, and/or when the item is otherwise not currently available (e.g., “back-ordered,” placed in a manufacturing and/or fulfillment queue, etc.).

### BRIEF DESCRIPTION OF THE DRAWINGS

FIGS. 1, 2A-2C, 3A-3C, and 4A-4C illustrate an example overview of one or more embodiments described herein;

FIG. 5 illustrates an example generation and/or refinement of one or more models in accordance with one or more embodiments described herein;

FIG. 6 illustrates the example use of one or more models in order to identify and implement order modification parameters associated with a given order, in accordance with one or more embodiments described herein;

FIG. 7 illustrates an example process for selectively modifying a position in an order queue for a modified order based on parameters associated with the order, in accordance with one or more embodiments described herein;

FIG. 8 illustrates an example environment in which one or more embodiments, described herein, may be implemented;

FIG. 9 illustrates an example arrangement of a radio access network (“RAN”), in accordance with some embodiments; and

FIG. 10 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

Organizations, enterprises, institutions, etc. may offer fulfillment of orders, where some orders are associated with a duration of time in between receiving an order (e.g., from a user and/or from a device associated with a user such as a User Equipment (“UE”) such as a mobile phone, laptop, tablet, etc.) for one or more goods, items, etc. and fulfilling the order (e.g., packaging and/or shipping the goods, items, etc. and/or otherwise fulfilling the order). For example, a given order may be a pre-order for an item that is scheduled to become available at a future date, may be an order for an item that is not constructed or built until some time after the order is received, and/or an order for which other orders (e.g., associated with other users or UEs) are ahead of the order in a queue prior to fulfillment.

In some situations, a user modifying such an order may result in the order being placed in the end (e.g., back) of the queue, thus losing the place of the original order in a queue. Thus, even relatively minor changes to an order, such as selecting a new color, storage size, set of accessories, etc. for a given item, may result in a delay for the user, thus potentially frustrating the user. In accordance with embodiments described herein, a technique may be provided by which users may not necessarily lose their place in an order queue when modifying an order. In some embodiments, some users, UEs, order types, and/or order modification types may be associated with different order modification parameters or restrictions, where some users may be able to modify an order without losing a place in an order queue.

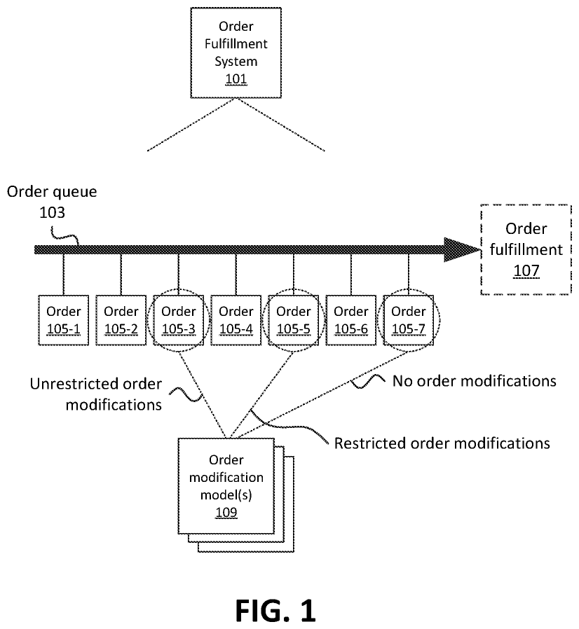

For example, as shown in FIG. 1, order fulfillment system 101 may maintain an order queue 103, which may include a sequence of orders 105. For example, orders 105 may be in a queue in between a time of order creation (e.g., receiving an order via a website, web portal, application or “app,” etc.) and order fulfillment 107, such as packaging an ordered item, shipping the ordered item, and/or otherwise exiting order queue 103 and/or completing a given order 105.

As shown, order queue 103 may include example orders 105-1 through 105-7. In this example, order 105-7 may be a nearest order to order fulfillment 107 (e.g., may be the next order to be fulfilled, may have the highest priority out of the set of orders 105, etc.), while order 105-1 may be a farthest order from order fulfillment 107 (e.g., may be at the back or end of order queue 103). For example, order 105-7 may have been received, created, etc. earlier than orders 105-1 through 105-6, and/or may otherwise be ahead of orders 105-1 through 105-6 in order queue 103.

Order fulfillment system 101 may further generate, maintain, modify, receive, etc. one or more order modification models 109. As discussed in more detail below, order modification models 109 may be used to identify different order modification parameters associated with different users, orders, UEs, etc. based on attributes of the users, orders, UEs, etc. For example, as shown, order 105-3 may be associated with an “unrestricted” order modification parameter, order 105-5 may be associated with a “restricted” order modification parameter, and order 105-7 may be associated with a “no” order modification parameter. Examples of how such parameters may apply in situations where orders 105-3, 105-5, and/or 105-7 are modified are described in the examples below.

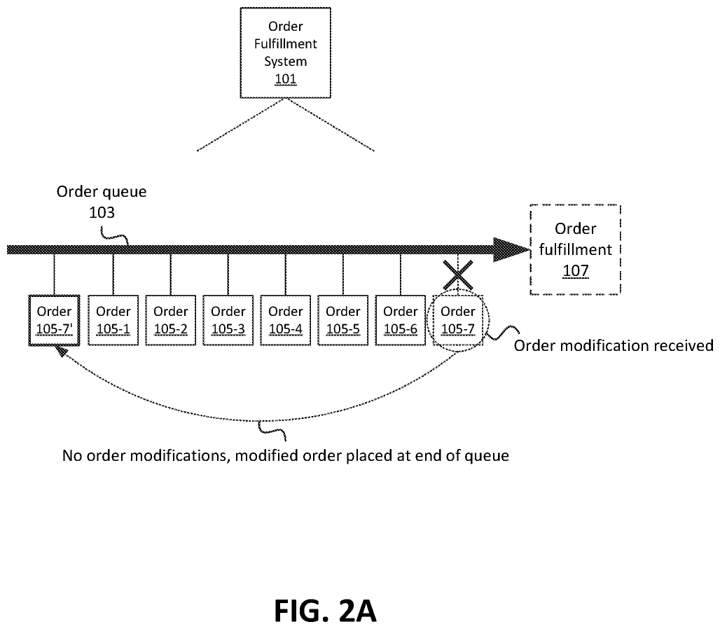

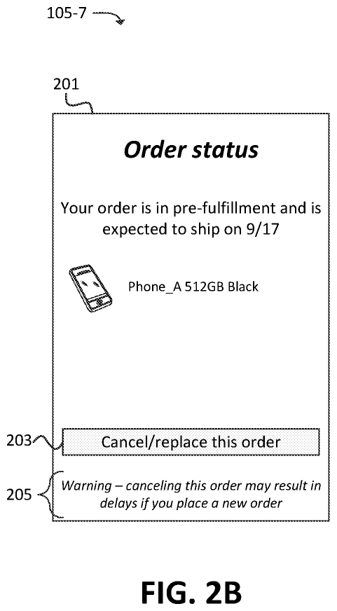

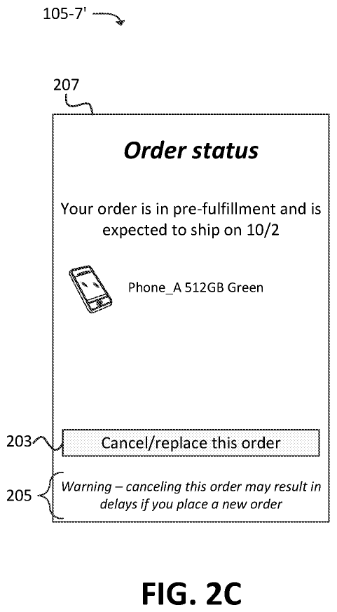

For example, as shown in FIG. 2A, order fulfillment system 101 may receive an indication that order 105-7 has been modified. For example, order fulfillment system 101 may receive, from a UE, via a web portal, via a web site, via an application programming interface (“API”), and/or in some other suitable manner, an indication that order 105-7 has been modified. As referred to herein, an order “modification” may include the removal of one or more items from an order, the addition of one or more items to the order, the selection of different attributes or options for one or more items of an order, or the like. In some embodiments, each order 105 may be associated with an order identifier or other suitable mechanism by which orders 105 and/or modifications to such orders 105 may be identified and/or tracked.

As shown, based on receiving the modification to order 105-7 and further based on the previously determined order modification parameters for order 105-7 (i.e., no order modifications, in this example), order fulfillment system 101 may place modified order 105-7′ at the end of order queue 103. For example, modified order 105-7′ may be, or may be treated as, a “new” order, and the modification of order 105-7 may be treated as a cancellation of order 105-7, based on the order cancellation parameter for order 105-7 (i.e., no order modifications, in this example).

FIG. 2B illustrates an example user interface (“UI”) 201, which may be presented by a UE or other type of device from which the order modification (e.g., the modification to order 105-7) is received. As shown, UI 201 may indicate that an item that was ordered, the “Phone_A 512 GB Black,” is in a “pre-fulfillment” status (e.g., has not been shipped, packed, released, etc.), and is expected to ship at a future date (“9/17,” in this example).

As order 105-7 is associated with a “no” order modifications parameter, as discussed above, UI 201 may include selectable option 203 (e.g., a button or other type of selectable or interactive UI element), which may be an option to cancel order 105-7. UI 201 may also include UI element 205, which may include text, icons, or another type of presentation of information, warning a user interacting with UI 201 that canceling the order (e.g., by selecting selectable option 203) may result in delays, and/or that canceling order 105-7 may result in replacing order 105-7 with a new order (e.g., order 105-7′).

FIG. 2C illustrates example UI 207, which may be presented by a UE or other type of device from which the order modification (e.g., the modification to order 105-7) is received, and/or some other device after the modification is made. As shown, UI 207 may indicate that an item different from the original order 105-7 has been ordered (e.g., “Phone_A 512 GB Green,” which is different from the “Phone_A 512 GB Black” as originally ordered). As further shown, based on the “no” order modification parameter associated with the original order 105-7, UI 207 may indicate a later date (e.g., “10/2” as opposed to “9/17” as shown in FIG. 2B) for fulfillment of modified order 105-7′ than for original order 105-7. In some embodiments, UI 207 may include the same selectable option 203 and/or UI element 205 as UI 201, based on replacement order 105-7′ and/or a user or UE associated with replacement order 105-7′ being associated with a “no” order modification parameter.

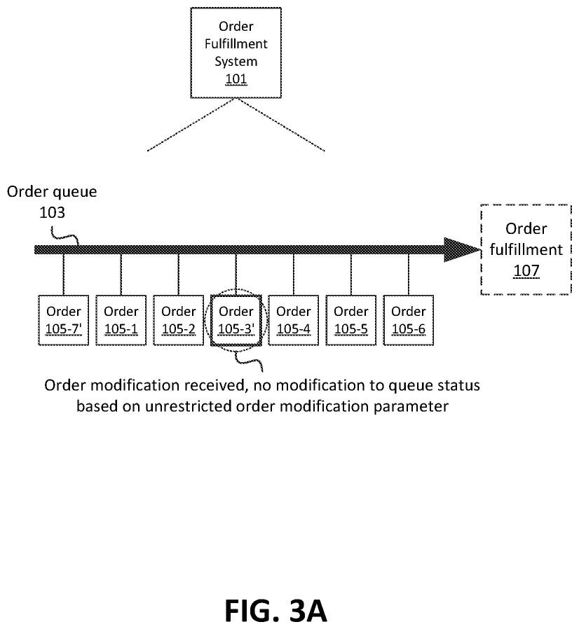

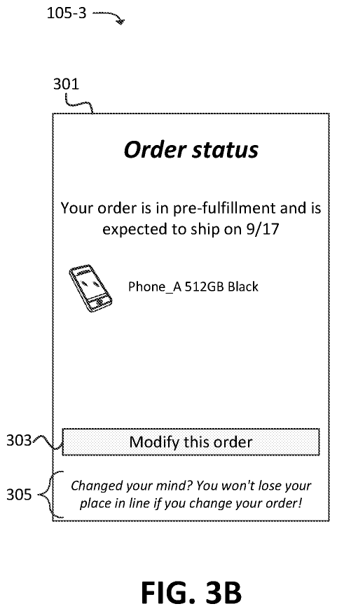

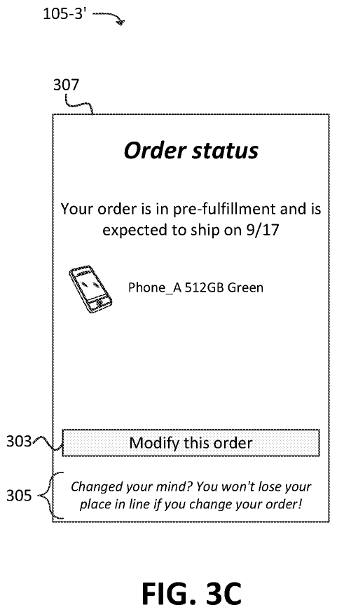

As shown in FIG. 3A, order fulfillment system 101 may receive an indication that order 105-3 has been modified. For example, order fulfillment system 101 may receive, from a UE, via a web portal, via a web site, via an API, and/or in some other suitable manner, an indication that order 105-3 has been modified. Based on receiving the modification to order 105-3, and further based on the previously determined order modification parameters for order 105-3 (i.e., unrestricted order modifications, in this example), order fulfillment system 101 may place modified order 105-3′ in the same position of order queue 103 as original order 105-3.

FIG. 3B illustrates example UI 301, which may be presented by a UE or other type of device from which the order modification (e.g., the modification to order 105-3) is received. As shown, UI 301 may indicate that an item that was ordered, the “Phone_A 512 GB Black,” is in a “pre-fulfillment” status (e.g., has not been shipped, packed, released, etc.), and is expected to ship at a future date (“9/17,” in this example).

As order 105-3 is associated with an “unrestricted” order modifications parameter, as discussed above, UI 301 may include selectable option 303 (e.g., a button or other type of selectable or interactive UI element), which may be an option to modify order 105-3. In some embodiments, UI 301 may include one or more other selectable options to cancel the order or to perform other suitable actions. UI 301 may also include UI element 305, which may include text, icons, or another type of presentation of information, indicating a user interacting with UI 301 that modifying the order (e.g., by selecting selectable option 303) will not result in additional delays (e.g., as compared to not modifying order 105-3), and/or that modifying order 105-3 will not result in placing modified order 105-3′ behind any other orders in an order queue.

FIG. 3C illustrates example UI 307, which may be presented by a UE or other type of device from which the order modification (e.g., the modification to order 105-3) is received, and/or some other device after the modification is made. As shown, UI 307 may indicate that an item different from the original order 105-3 has been ordered (e.g., “Phone_A 512 GB Green,” which is different from the “Phone_A 512 GB Black” as originally ordered). As further shown, based on the “unrestricted” order modification parameter associated with the original order 105-3, UI 307 may indicate the same date (e.g., “9/17” as shown in FIG. 3B) for fulfillment of modified order 105-3′ as for original order 105-3. In some embodiments, UI 307 may include the same selectable option 303 and/or UI element 305 as UI 301, based on replacement order 105-3′ and/or a user or UE associated with replacement order 105-3′ being associated with an “unrestricted” order modification parameter.

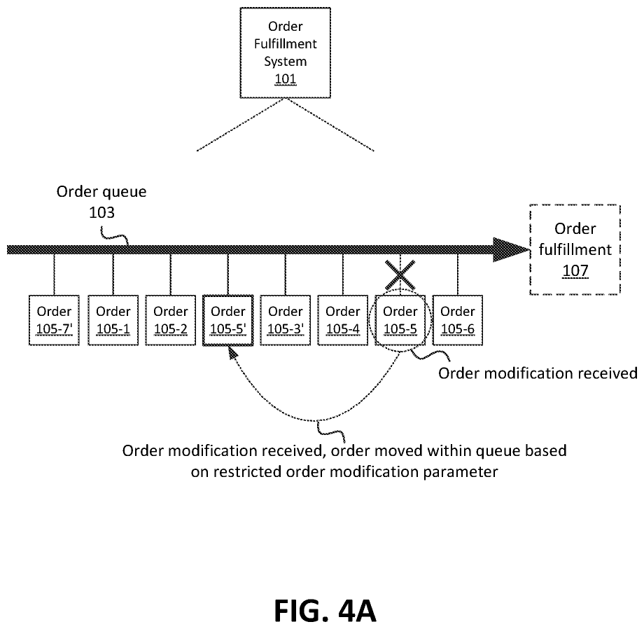

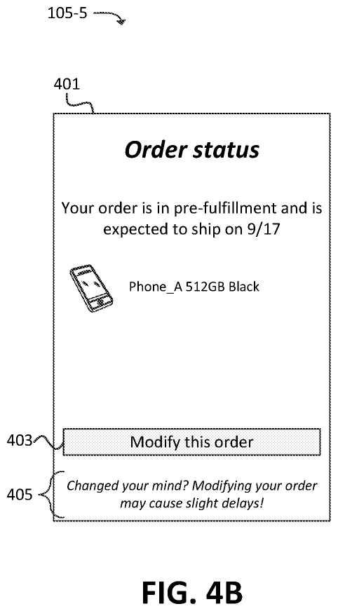

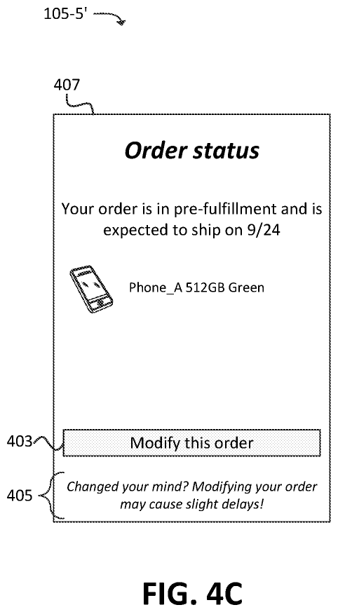

As shown in FIG. 4A, order fulfillment system 101 may receive an indication that order 105-5 has been modified. For example, order fulfillment system 101 may receive, from a UE, via a web portal, via a web site, via an API, and/or in some other suitable manner, an indication that order 105-5 has been modified. Based on receiving the modification to order 105-5, and further based on the previously determined order modification parameters for order 105-5 (i.e., restricted order modifications, in this example), order fulfillment system 101 may place modified order 105-5′ in a different (e.g., later, lower, etc.) position in order queue 103 than its original position in order queue 103. However, the different position for modified order 105-5′ may not be the end of order queue 103, as modified order 105-7′ was placed. For example, based on the “restricted” order modification parameter for order 105-5, order fulfillment system 101 may move order 105-5′ to a position in order queue 103 that is a predetermined quantity of spaces, slots, etc. that is lower than the position of original order 105-5, and/or may otherwise move order 105-5 to a different position within order queue 103 that is not necessarily the end of order queue 103.

FIG. 4B illustrates example UI 401, which may be presented by a UE or other type of device from which the order modification (e.g., the modification to order 105-5) is received. As shown, UI 401 may indicate that an item that was ordered, the “Phone_A 512 GB Black,” is in a “pre-fulfillment” status (e.g., has not been shipped, packed, released, etc.), and is expected to ship at a future date (“9/17,” in this example).

As order 105-5 is associated with a “restricted” order modifications parameter, as discussed above, UI 401 may include selectable option 403 (e.g., a button or other type of selectable or interactive UI element), which may be an option to modify order 105-5. In some embodiments, UI 401 may include one or more other selectable options to cancel the order or to perform other suitable actions. UI 401 may also include UI element 405, which may include text, icons, or another type of presentation of information, indicating a user interacting with UI 401 that modifying the order (e.g., by selecting selectable option 403) may result in additional delays (e.g., as compared to not modifying order 105-5), and/or that modifying order 105-5 will result in placing modified order 105-5′ in a different position within an order queue, which may include placing modified order 105-5′ behind one or more other exiting orders in the order queue.

FIG. 4C illustrates example UI 307, which may be presented by a UE or other type of device from which the order modification (e.g., the modification to order 105-5) is received, and/or some other device after the modification is made. As shown, UI 407 may indicate that an item different from the original order 105-5 has been ordered (e.g., “Phone_A 512 GB Green,” which is different from the “Phone_A 512 GB Black” as originally ordered). As further shown, based on the “restricted” order modification parameter associated with the original order 105-5, UI 407 may indicate a later date (e.g., “9/24” as opposed to “9/17” as shown in FIG. 4B) for fulfillment of modified order 105-5′ than for original order 105-5. Thus, although orders 105-5′ and 105-7′ are both modified orders, these different orders may be associated with different delays as compared to fulfillment dates associated with original orders 105-5 and 105-7, respectively. For example, since order 105-5 is associated with a “restricted” order modification parameter, the delay for modified order 105-5′ may be less than the delay for modified order 105-7′. In some embodiments, UI 407 may include the same selectable option 403 and/or UI element 405 as UI 401, based on replacement order 105-5′ and/or a user or UE associated with replacement order 105-5′ being associated with a “restricted” order modification parameter.

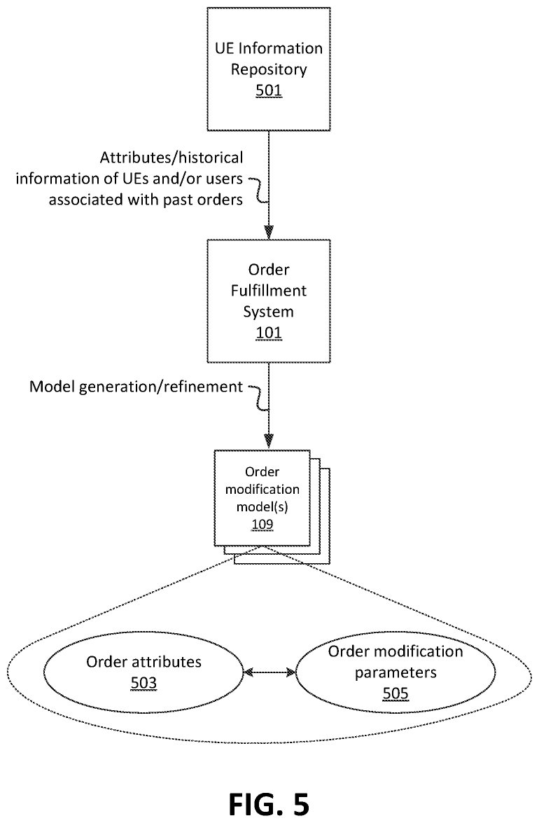

FIG. 5 illustrates an example generation and/or refinement of one or more models in accordance with one or more embodiments described herein, based on which order fulfillment system 101 may identify one or more order modification parameters for a given order 105, UE, and/or user. For example, as shown, order fulfillment system 101 may receive attributes, historical information, and/or other suitable types of information associated with one or more UEs, users, or orders. In some embodiments, order fulfillment system 101 may receive such information from UE information repository 501, which may include a Home Subscriber Server (“HSS”), a Unified Data Management function (“UDM”), and/or some other device or system that performs operations related to the maintaining and/or providing of user information, UE information, and/or order information. In some embodiments, the information provided by UE information repository 501 may include information such as web sites or applications accessed by one or more users or UEs who have placed orders in the past (e.g., prior to the generation and/or refinement of the one or more models), web searches performed by such users or UEs, information regarding a social media account of such users or UEs, etc.

As one example, the information maintained, provided, etc. by UE information repository 501 may include information indicating that a particular user has previously placed an order, canceled the order, and placed a new order within a threshold amount of time. As another example, the information provided by UE information repository 501 may indicate that a particular user has previously placed an order, canceled the order, and placed a new order that includes the same or similar item as the original order. For example, the new order that includes the “same or similar item” may include an order for different attributes of the same item (e.g., a different color, a different storage size, etc.), an order for a different item of the same type or category (e.g., a mobile phone, a laptop, a tablet, an Internet of Things (“IoT”) device, etc.), and/or some other type of item that has an identifiable correlation with an item that is included in the original order.

As another example, the information provided by UE information repository 501 may indicate a membership status or length with a given provider, vendor, organization, etc. For example, different users or UEs may be associated with different membership levels, such as “gold,” “silver,” “preferred,” “basic,” or the like. In some embodiments, different users or UEs may be associated with other suitable types of categories, classifications, etc.

In some embodiments, the information provided by UE information repository 501 may indicate that a given user performed one or more web searches after placing an order, and then subsequently modified or canceled the order after performing the one or more web searches. For example, the user may have changed his or her mind with respect to an ordered item after performing the one or more web searches.

As another example, the information provided by UE information repository 501 may indicate that a given user posted or otherwise interacted with one or more social media platforms before and/or after (e.g., within a threshold amount of time) placing an order, canceling an order, modifying an order, and/or otherwise creating a replacement order for an original order. For example, the user may have posted a “like” on a given item and then modified a previous order to include the item that the user “liked.”

In some embodiments, the information provided by UE information repository 501 may include attribute and/or usage information associated with a given UE associated with a user who has placed an order. For example, the information may indicate a make and/or model of a UE associated with the user, an amount of data usage associated with the UE (e.g., over the past week, over the past month, over a particular timeframe, etc.), attributes of the UE (e.g., storage size, color, etc.).

In some embodiments, the information provided by UE information repository 501 may include information regarding “recommended” or “predicted” items for a given user. For example, a particular device or system may have recommended a particular item for a particular user, which the user may have ordered, and then modified or canceled the order.

As further shown, order fulfillment system 101 may generate and/or refine one or more order modification models 109 based on the received information. For example, order fulfillment system 101 may use one or more AI/ML techniques, such as a random forest technique, a neural network technique, or one or more other suitable techniques in order to generate or modify order modification models 109. In some embodiments, order modification models 109 may include identifying features, attributes, etc. of users, UEs, and/or orders (referred to herein as “order attributes 503”) that are correlated to particular order modification parameters 505. In some embodiments, such correlations may be determined by way of supervised and/or unsupervised machine learning techniques, manually specified correlations, and/or some other suitable process.

For example, one such correlation associated with order modification model 109 may include an indication that users who have historically placed a replacement order within a threshold amount of time after canceling a previous order should be associated with an “unrestricted” order parameter. As another example, a correlation associated with order modification model 109 may include an indication that users associated with a “gold” or “premier” membership should be associated with an “unrestricted” order parameter, while the same or a different correlation associated with order modification model 109 may include an indication that users associated with a “silver” or different type of membership should be associated with a “restricted” order parameter or a “no” order parameter. As another example, order modification model 109 may include a correlation indicating that users who posted a “like” or “comment” on a social media platform about an item after placing an order for a different item should be associated with an “unrestricted” or “restricted” order parameter. As yet another example, order modification model 109 may include a correlation indicating that users who were provided with a recommended item but subsequently ordered a different item should be associated with an “unrestricted” order parameter.

In some embodiments, a set of order attributes 503 may indicate attributes of orders or order modifications themselves. For example, one set of order attributes 503 may indicate a relatively minor order modification, such as the modification of a parameter of an item (e.g., color, size, etc.) that was already included in a previous order. Another set of order attributes 503 may indicate a relatively major order modification, such as the replacement of one item with one or more other items, or other types of changes. In some embodiments, order modification model 109 may correlate certain types of order modifications to different order modification parameters 505. For example, Order modification model 109 may correlate “minor” order modifications (e.g., a first type of order modification) to a first set of order modification parameters 505 (e.g., an “unrestricted” order modification parameter), while “major” order modifications (e.g., a second type of order modification) may be correlated with a second set of order modification parameters 505 (e.g., a “restricted” or “no” order modification parameter).

While some examples of order attributes 503 and correlated order modification parameters 505 are provided above, in some embodiments, order modification model 109 may include different correlations between particular order attributes 503 and order modification parameters 505. Further, in some embodiments, order modification model 109 may include correlations between additional or different order attributes 503 than the examples provided above.

In some embodiments, different order attributes 503 may be associated with different scores, and particular order modification parameters 505 may be associated with particular scores or ranges of scores. For example, an “unrestricted” order modification parameter may be associated with a score between 80 and 100 (e.g., on an example scale of 1-100), a “restricted” order modification parameter may be associated with a score between 60 and 79, and a “no” order modification parameter may be a associated with a score below 59. In some embodiments, different levels of order parameters may be associated with different scores (e.g., on a “sliding scale”). For example, a score of 69 may be associated with a different level of “restricted” order modifications than a score of 62. That is, a user who is associated with a score of 69 may have his or her modified order moved back 3 positions in order queue 103, while a user how is associated with a score of 62 may have his or her modified order moved back 7 positions (e.g., a different quantity of positions) in order queue 103.

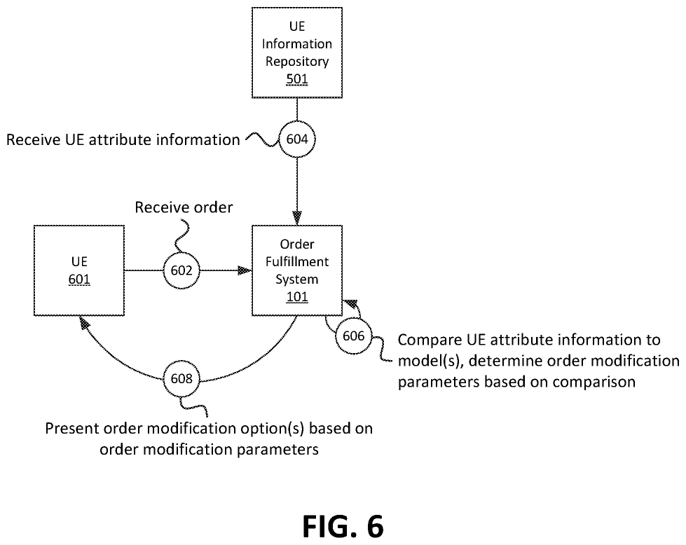

As shown in FIG. 6, the one or more models 109 may be applied (e.g., at “run-time”) in order to assign a particular order modification parameter to an order, UE, user, etc. based on a received order. For example, order fulfillment system 101 may receive (at 602) an order from UE 601, and/or may otherwise receive an indication that UE 601 has placed the order. For example, order fulfillment system 101 may implement, provide, etc. a web portal, an API, and/or some other suitable communication pathway by which order fulfillment system 101 may receive (at 602) the order indication from UE 601 and/or some other device or system. Order fulfillment system 101 may also receive (at 604) UE attribute information associated with UE 601. For example, order fulfillment system 101 may query UE information repository 501 by providing an identifier of UE 601 (e.g., a Mobile Directory Number (“MDN”), an International Mobile Subscriber Identity (“IMSI”) value, an International Mobile Station Equipment Identity (“IMEI”) value, an Internet Protocol (“IP”) address, and/or other one or more other suitable identifiers based on which UE 601 may be identified) and/or identifying information regarding a user with which the order is associated, such as the user's name, address, user identifier, etc. In some embodiments, some or all of the UE attribute information may be received from UE 601 via an API between UE 601 and order fulfillment system 101 and/or some other suitable communication pathway.

Order fulfillment system 101 may compare (at 606) the UE attribute information to one or more order modification models 109 (e.g., which may be generated or refined as discussed above). For example, order fulfillment system 101 may determine a measure of similarity between one or more of the attributes, associated with UE 601 and/or a user of UE 601, and a set of attributes 503 of one or more models 109. Order fulfillment system 101 may identify a “best fit” set of order attributes 503 (e.g., a set of order attributes 503 bearing a highest measure of similarity to the attributes of UE 601 and/or the user of UE 601), and/or may otherwise determine a set of order attributes 503 based on the attributes of UE 601 and/or the user of UE 601. Order fulfillment system 101 may accordingly identify a particular set of order modification parameters 505 that are associated with (e.g., correlated with, as indicated by model 109) the identified set of order attributes 503.

Order fulfillment system 101 may present (at 608) order modification options based on the identified order modification parameters. For example, order fulfillment system 101 may present such options as part of a web page or other suitable UI when UE 601 accesses an order status page (e.g., as presented by order fulfillment system 101 or some other suitable device or system). Additionally, or alternatively, order fulfillment system 101 may indicate the identified order modification parameters to an application, API, etc. associated with UE 601, and UE 601 may accordingly present the order modification parameters in a UI presented by UE 601 (e.g., as similarly discussed above with respect to example FIGS. 2B, 3B, and/or 4B).

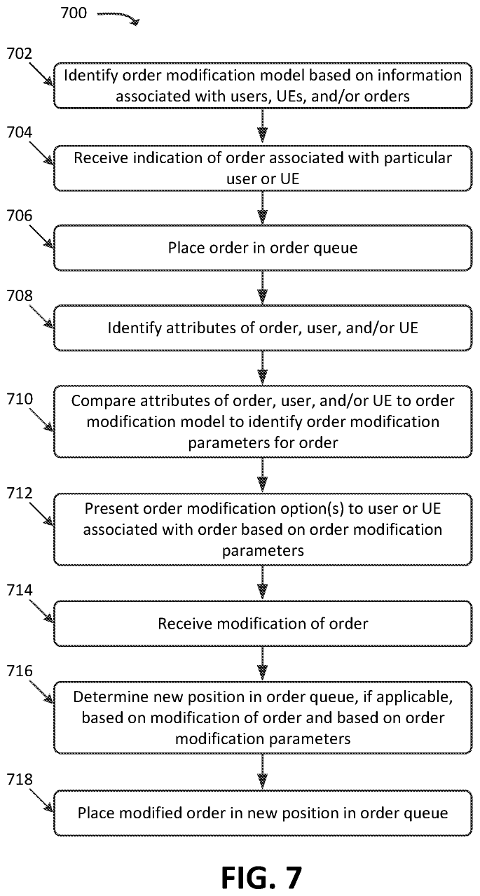

FIG. 7 illustrates an example process 700 for selectively modifying a position in an order queue for a modified order based on order modification parameters associated with the order, in accordance with one or more embodiments. In some embodiments, some or all of process 700 may be performed by order fulfillment system 101. In some embodiments, one or more other devices may perform some or all of process 700 in concert with, and/or in lieu of, order fulfillment system 101.

As shown, process 700 may include identifying (at 702) an order modification model based on information associated with users, UEs, and/or orders. For example, as discussed above, order fulfillment system 101 may receive information UE information repository 501, UEs 601, and/or other devices or systems regarding a set of orders that have been placed in the past. The information may include attributes associated with the orders, which may include attributes or users that have placed the orders and/or of UEs 601 associated with users who have placed the orders. In some embodiments, the order attributes may include actions taken with respect to orders, such as placing the orders, modifying the orders, canceling the orders, placing sequences of orders and/or order modifications or cancellations, or the like. In some embodiments, the order attributes may include membership levels or categories associated with users who have placed or modified past orders. In some embodiments, the order attributes may include information regarding social media interactions by users who have placed or modified past orders. In some embodiments, the order attributes may include attributes of items that were included in past orders, such as make or model, color, size, etc.

In some embodiments, as discussed above, order fulfillment system 101 and/or some other device or system may generate or modify one or more order modification models 109 based on the received information regarding past orders. As noted above, order modification models 109 may correlate sets of attributes (e.g., order attributes 503) to particular sets of order modification parameters (e.g., order modification parameters 505). Such order modification parameters 505 may indicate, for example, how modifications to placed orders (e.g., orders that are in an order queue 103) should be handled. For example, a first set of order modification parameters 505 may specify that a modified order should be placed in the same position in order queue 103 as an original order that the modified order replaces. As another example, a second set of order modification parameters 505 may specify that a modified order should be placed at the end of order queue 103. In some embodiments, the second set of order modification parameters 505 may further specify that the original order should be removed from its current position in order queue 103. As yet another example, a third set of order modification parameters 505 may specify that a modified order should be moved back in order queue 103 (e.g., to a “lower” or “lesser” position in order queue 103), but not necessarily to the end of order queue 103. For example, the third set of order modification parameters 505 may specify a quantity of positions that the modified order should be placed behind the position of the original order, and/or may otherwise specify a degree to which the modified order should be placed behind the position of the original order. As such, different orders having different parameters (e.g., which may include parameters of users and/or UEs associated with such orders) may be correlated with different sets of order modification parameters.

Process 700 may further include receiving (at 704) an indication of an order associated with a particular user or UE 601. For example, order fulfillment system 101 may receive an order from UE 601 via a web site, a web portal, an API, etc., and/or may receive an indication of an order being placed from some other device or system.

Process 700 may additionally include placing (at 706) the order in order queue 103. For example, order fulfillment system 101 may place the order at the end of order queue 103, and/or may place the order in some other suitable position within order queue 103.

Process 700 may also include identifying (at 708) attributes of the order, which may include identifying attributes of a user and/or UE 601 associated with the order. In some embodiments, the attributes may be included in the order itself, and/or may be received from UE information repository 501 or some other suitable device or system.

Process 700 may further include comparing (at 710) attributes of the order (which may include attributes of a user and/or UE 601 associated with the order) to order modification model 109 in order to identify order modification parameters for the order. For example, order fulfillment system 101 may generate one or more scores for the order based on the attributes of the order and order attributes indicated in order modification model 109. In some embodiments, such scores may indicate a measure of similarity and/or correlation between the attributes of the received order and order attributes included in order modification model 109. Order fulfillment system 101 may identify a particular set of order attributes 503, included in order modification model 109, that match the attributes of the received order. For example, the particular set of order attributes 503 may “match” the attributes of the received order when the particular set of order attributes 503 is associated with a highest measure of similarity or correlation with the attributes of the received order. In some embodiments, order fulfillment system 101 may use any suitable type of similarity or correlation analysis to identify the particular set of order attributes 503 associated with the highest measure of similarity or correlation with the attributes of the received order. In some embodiments, order fulfillment system 101 may use some other type of selection scheme to identify the particular set of order attributes 503 based on the attributes of the received order. Based on the identified set of order attributes 503, order fulfillment system 101 may identify a set of order modification parameters 505 indicated by order modification model 109 as being associated with the identified set of order attributes 503.

Process 700 may additionally include presenting (at 712) one or more order modification options to a user or UE 601 associated with the order based on the identified order modification parameters 505. For example, as discussed above, order fulfillment system 101 may provide information based on which UE 601 may present a UI (e.g., as discussed above with respect to example UIs 201, 301, and 401) that includes one or more options (e.g., selectable options 203, 303, and/or 403) to cancel and/or modify the order. In some embodiments, as discussed above, different selectable options may be associated with different sets of order modification parameters 505.

Process 700 may also include receiving (at 714) a modification of the order. For example, order fulfillment system 101 may receive an indication that a particular selectable option (e.g., as provided at 712) has been selected. The modified order may be a replacement order for the original order (received at 704).

Process 700 may further include determining a new position (at 716) in order queue 103, if applicable, based on the modification of the order and further based on the identified order modification parameters 505 for the order. For example, as discussed above, some order modification parameters 505 may indicate that an order is “unrestricted” for order modifications, based on which the position for the new, modified, replacement, etc. order (referred to as the “modified order”) should be the same as the position for the original order. As also discussed above, some order modification parameters 505 may indicate that the modified order should be moved to the end of order queue 103 (e.g., based on which the modified order may be placed behind one or more orders that were previously behind the original order in order queue 103), and/or that the modified order should be moved back in order queue 103 relative to the position of the original order, but not necessarily to the end of order queue 103.

Process 700 may additionally include placing (at 718) the modified order in the new position in order queue 103. For example, order fulfillment system 101 may remove the original order from order queue 103 and place the modified order in the determined position in order queue 103. As discussed above, the determined position may, in some situations, be the same position as the original order. In other situations, the determined position may be a different position from the original order (e.g., the end of order queue 103 and/or some other position within order queue 103).

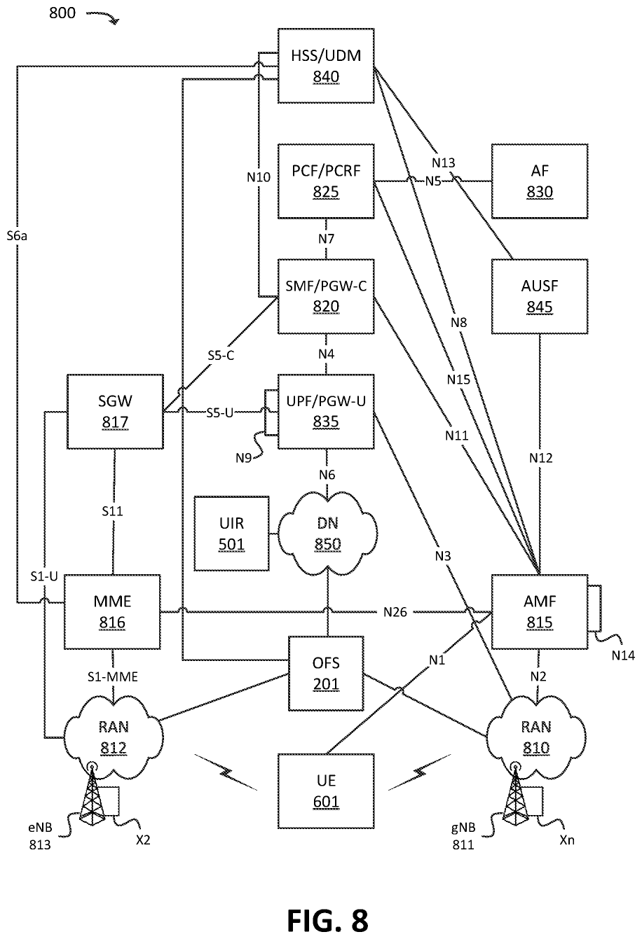

FIG. 8 illustrates an example environment 800, in which one or more embodiments may be implemented. In some embodiments, environment 800 may correspond to a Fifth Generation (“5G”) network, and/or may include elements of a 5G network. In some embodiments, environment 800 may correspond to a 5G Non-Standalone (“NSA”) architecture, in which a 5G radio access technology (“RAT”) may be used in conjunction with one or more other RATs (e.g., a Long-Term Evolution (“LTE”) RAT), and/or in which elements of a 5G core network may be implemented by, may be communicatively coupled with, and/or may include elements of another type of core network (e.g., an evolved packet core (“EPC”)). As shown, environment 800 may include UE 601, RAN 810 (which may include one or more Next Generation Node Bs (“gNBs”) 811), RAN 812 (which may include one or more one or more evolved Node Bs (“eNBs”) 813), and various network functions such as Access and Mobility Management Function (“AMF”) 815, Mobility Management Entity (“MME”) 816, Serving Gateway (“SGW”) 817, Session Management Function (“SMF”)/Packet Data Network (“PDN”) Gateway (“PGW”)-Control plane function (“PGW-C”) 820, Policy Control Function (“PCF”)/Policy Charging and Rules Function (“PCRF”) 825, Application Function (“AF”) 830, User Plane Function (“UPF”)/PGW-User plane function (“PGW-U”) 835, Home Subscriber Server (“HSS”)/Unified Data Management (“UDM”) 840, and Authentication Server Function (“AUSF”) 845. Environment 800 may also include one or more networks, such as Data Network (“DN”) 850. Environment 800 may include one or more additional devices or systems communicatively coupled to one or more networks (e.g., DN 850), such as order fulfillment system 101 and/or UE information repository 501, which may perform one or more operations described above.

The example shown in FIG. 8 illustrates one instance of each network component or function (e.g., one instance of SMF/PGW-C 820, PCF/PCRF 825, UPF/PGW-U 835, HSS/UDM 840, and/or AUSF 845). In practice, environment 800 may include multiple instances of such components or functions. For example, in some embodiments, environment 800 may include multiple “slices” of a core network, where each slice includes a discrete set of network functions (e.g., one slice may include a first instance of SMF/PGW-C 820, PCF/PCRF 825, UPF/PGW-U 835, HSS/UDM 840, and/or AUSF 845, while another slice may include a second instance of SMF/PGW-C 820, PCF/PCRF 825, UPF/PGW-U 835, HSS/UDM 840, and/or AUSF 845). The different slices may provide differentiated levels of service, such as service in accordance with different Quality of Service (“QoS”) parameters.

The quantity of devices and/or networks, illustrated in FIG. 8, is provided for explanatory purposes only. In practice, environment 800 may include additional devices and/or networks, fewer devices and/or networks, different devices and/or networks, or differently arranged devices and/or networks than illustrated in FIG. 8. For example, while not shown, environment 800 may include devices that facilitate or enable communication between various components shown in environment 800, such as routers, modems, gateways, switches, hubs, etc. Alternatively, or additionally, one or more of the devices of environment 800 may perform one or more network functions described as being performed by another one or more of the devices of environment 800. Devices of environment 800 may interconnect with each other and/or other devices via wired connections, wireless connections, or a combination of wired and wireless connections. In some implementations, one or more devices of environment 800 may be physically integrated in, and/or may be physically attached to, one or more other devices of environment 800.

UE 601 may include a computation and communication device, such as a wireless mobile communication device that is capable of communicating with RAN 810, RAN 812, and/or DN 850. UE 601 may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an IoT device (e.g., a sensor, a smart home appliance, or the like), a wearable device, an Internet of Things (“IoT”) device, a Machine-to-Machine (“M2M”) device, or another type of mobile computation and communication device. UE 601 may send traffic to and/or receive traffic (e.g., user plane traffic) from DN 850 via RAN 810, RAN 812, and/or UPF/PGW-U 835.

RAN 810 may be, or may include, a 5G RAN that includes one or more base stations (e.g., one or more gNBs 811), via which UE 601 may communicate with one or more other elements of environment 800. UE 601 may communicate with RAN 810 via an air interface (e.g., as provided by gNB 811). For instance, RAN 810 may receive traffic (e.g., voice call traffic, data traffic, messaging traffic, signaling traffic, etc.) from UE 601 via the air interface, and may communicate the traffic to UPF/PGW-U 835, and/or one or more other devices or networks. Similarly, RAN 810 may receive traffic intended for UE 601 (e.g., from UPF/PGW-U 835, AMF 815, and/or one or more other devices or networks) and may communicate the traffic to UE 601 via the air interface.

RAN 812 may be, or may include, a LTE RAN that includes one or more base stations (e.g., one or more eNBs 813), via which UE 601 may communicate with one or more other elements of environment 800. UE 601 may communicate with RAN 812 via an air interface (e.g., as provided by eNB 813). For instance, RAN 810 may receive traffic (e.g., voice call traffic, data traffic, messaging traffic, signaling traffic, etc.) from UE 601 via the air interface, and may communicate the traffic to UPF/PGW-U 835, and/or one or more other devices or networks. Similarly, RAN 810 may receive traffic intended for UE 601 (e.g., from UPF/PGW-U 835, SGW 817, and/or one or more other devices or networks) and may communicate the traffic to UE 601 via the air interface.

AMF 815 may include one or more devices, systems, Virtualized Network Functions (“VNFs”), etc., that perform operations to register UE 601 with the 5G network, to establish bearer channels associated with a session with UE 601, to hand off UE 601 from the 5G network to another network, to hand off UE 601 from the other network to the 5G network, manage mobility of UE 601 between RANs 810 and/or gNBs 811, and/or to perform other operations. In some embodiments, the 5G network may include multiple AMFs 815, which communicate with each other via the N14 interface (denoted in FIG. 8 by the line marked “N14” originating and terminating at AMF 815).

MME 816 may include one or more devices, systems, VNFs, etc., that perform operations to register UE 601 with the EPC, to establish bearer channels associated with a session with UE 601, to hand off UE 601 from the EPC to another network, to hand off UE 601 from another network to the EPC, manage mobility of UE 601 between RANs 812 and/or eNBs 813, and/or to perform other operations.

SGW 817 may include one or more devices, systems, VNFs, etc., that aggregate traffic received from one or more eNBs 813 and send the aggregated traffic to an external network or device via UPF/PGW-U 835. Additionally, SGW 817 may aggregate traffic received from one or more UPF/PGW-Us 835 and may send the aggregated traffic to one or more eNBs 813. SGW 817 may operate as an anchor for the user plane during inter-eNB handovers and as an anchor for mobility between different telecommunication networks or RANs (e.g., RANs 810 and 812).

SMF/PGW-C 820 may include one or more devices, systems, VNFs, etc., that gather, process, store, and/or provide information in a manner described herein. SMF/PGW-C 820 may, for example, facilitate the establishment of communication sessions on behalf of UE 601. In some embodiments, the establishment of communications sessions may be performed in accordance with one or more policies provided by PCF/PCRF 825.

PCF/PCRF 825 may include one or more devices, systems, VNFs, etc., that aggregate information to and from the 5G network and/or other sources. PCF/PCRF 825 may receive information regarding policies and/or subscriptions from one or more sources, such as subscriber databases and/or from one or more users (such as, for example, an administrator associated with PCF/PCRF 825).

AF 830 may include one or more devices, systems, VNFs, etc., that receive, store, and/or provide information that may be used in determining parameters (e.g., quality of service parameters, charging parameters, or the like) for certain applications.

UPF/PGW-U 835 may include one or more devices, systems, VNFs, etc., that receive, store, and/or provide data (e.g., user plane data). For example, UPF/PGW-U 835 may receive user plane data (e.g., voice call traffic, data traffic, etc.), destined for UE 601, from DN 850, and may forward the user plane data toward UE 601 (e.g., via RAN 810, SMF/PGW-C 820, and/or one or more other devices). In some embodiments, multiple UPFs 835 may be deployed (e.g., in different geographical locations), and the delivery of content to UE 601 may be coordinated via the N9 interface (e.g., as denoted in FIG. 8 by the line marked “N9” originating and terminating at UPF/PGW-U 835). Similarly, UPF/PGW-U 835 may receive traffic from UE 601 (e.g., via RAN 810, SMF/PGW-C 820, and/or one or more other devices), and may forward the traffic toward DN 850. In some embodiments, UPF/PGW-U 835 may communicate (e.g., via the N4 interface) with SMF/PGW-C 820, regarding user plane data processed by UPF/PGW-U 835.

HSS/UDM 840 and AUSF 845 may include one or more devices, systems, VNFs, etc., that manage, update, and/or store, in one or more memory devices associated with AUSF 845 and/or HSS/UDM 840, profile information associated with a subscriber. AUSF 845 and/or HSS/UDM 840 may perform authentication, authorization, and/or accounting operations associated with the subscriber and/or a communication session with UE 601. In some embodiments, UE information repository 501 may be, may include, may be implemented by, and/or may be communicatively coupled to HSS/UDM 840.

DN 850 may include one or more wired and/or wireless networks. For example, DN 850 may include an Internet Protocol (“IP”)-based PDN, a wide area network (“WAN”) such as the Internet, a private enterprise network, and/or one or more other networks. UE 601 may communicate, through DN 850, with data servers, other UEs 601, and/or to other servers or applications that are coupled to DN 850. DN 850 may be connected to one or more other networks, such as a public switched telephone network (“PSTN”), a public land mobile network (“PLMN”), and/or another network. DN 850 may be connected to one or more devices, such as content providers, applications, web servers, and/or other devices, with which UE 601 may communicate.

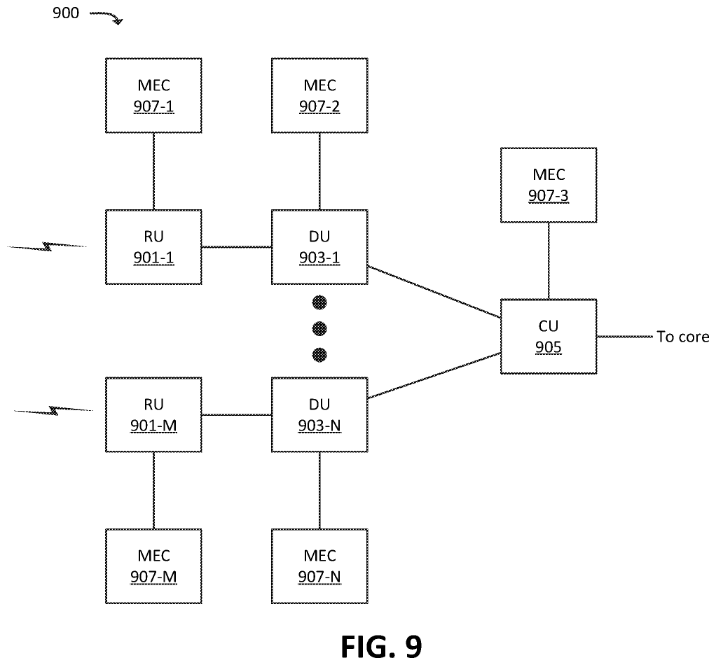

FIG. 9 illustrates an example Distributed Unit (“DU”) network 900, which may be included in and/or implemented by one or more RANs (e.g., RAN 810, RAN 812, or some other RAN). In some embodiments, a particular RAN may include one DU network 900. In some embodiments, a particular RAN may include multiple DU networks 900. In some embodiments, DU network 900 may correspond to a particular gNB 811 of a 5G RAN (e.g., RAN 810). In some embodiments, DU network 900 may correspond to multiple gNBs 811. In some embodiments, DU network 900 may correspond to one or more other types of base stations of one or more other types of RANs. As shown, DU network 900 may include Central Unit (“CU”) 905, one or more Distributed Units (“DUs”) 903-1 through 903-N (referred to individually as “DU 903,” or collectively as “DUs 903”), and one or more Radio Units (“RUs”) 901-1 through 901-M (referred to individually as “RU 901,” or collectively as “RUs 901”).

CU 905 may communicate with a core of a wireless network (e.g., may communicate with one or more of the devices or systems described above with respect to FIG. 8, such as AMF 815 and/or UPF/PGW-U 835). In the uplink direction (e.g., for traffic from UEs 601 to a core network), CU 905 may aggregate traffic from DUs 903, and forward the aggregated traffic to the core network. In some embodiments, CU 905 may receive traffic according to a given protocol (e.g., Radio Link Control (“RLC”)) from DUs 903, and may perform higher-layer processing (e.g., may aggregate/process RLC packets and generate Packet Data Convergence Protocol (“PDCP”) packets based on the RLC packets) on the traffic received from DUs 903.

In accordance with some embodiments, CU 905 may receive downlink traffic (e.g., traffic from the core network) for a particular UE 601, and may determine which DU(s) 903 should receive the downlink traffic. DU 903 may include one or more devices that transmit traffic between a core network (e.g., via CU 905) and UE 601 (e.g., via a respective RU 901). DU 903 may, for example, receive traffic from RU 901 at a first layer (e.g., physical (“PHY”) layer traffic, or lower PHY layer traffic), and may process/aggregate the traffic to a second layer (e.g., upper PHY and/or RLC). DU 903 may receive traffic from CU 905 at the second layer, may process the traffic to the first layer, and provide the processed traffic to a respective RU 901 for transmission to UE 601.

RU 901 may include hardware circuitry (e.g., one or more RF transceivers, antennas, radios, and/or other suitable hardware) to communicate wirelessly (e.g., via an RF interface) with one or more UEs 601, one or more other DUs 903 (e.g., via RUs 901 associated with DUs 903), and/or any other suitable type of device. In the uplink direction, RU 901 may receive traffic from UE 601 and/or another DU 903 via the RF interface and may provide the traffic to DU 903. In the downlink direction, RU 901 may receive traffic from DU 903, and may provide the traffic to UE 601 and/or another DU 903.

RUs 901 may, in some embodiments, be communicatively coupled to one or more Multi-Access/Mobile Edge Computing (“MEC”) devices, referred to sometimes herein simply as “MECs” 907. For example, RU 901-1 may be communicatively coupled to MEC 907-1, RU 901-M may be communicatively coupled to MEC 907-M, DU 903-1 may be communicatively coupled to MEC 907-2, DU 903-N may be communicatively coupled to MEC 907-N, CU 905 may be communicatively coupled to MEC 907-3, and so on. MECs 907 may include hardware resources (e.g., configurable or provisionable hardware resources) that may be configured to provide services and/or otherwise process traffic to and/or from UE 601, via a respective RU 901.

For example, RU 901-1 may route some traffic, from UE 601, to MEC 907-1 instead of to a core network (e.g., via DU 903 and CU 905). MEC 907-1 may process the traffic, perform one or more computations based on the received traffic, and may provide traffic to UE 601 via RU 901-1. In this manner, ultra-low latency services may be provided to UE 601, as traffic does not need to traverse DU 903, CU 905, and an intervening backhaul network between DU network 900 and the core network. In some embodiments, MEC 907 may include, and/or may implement, some or all of the functionality described above with respect to order fulfillment system 101.

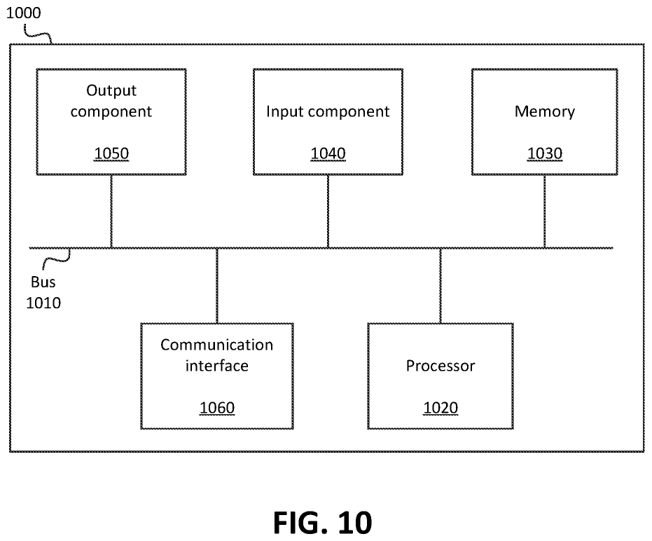

FIG. 10 illustrates example components of device 1000. One or more of the devices described above may include one or more devices 1000. Device 1000 may include bus 1010, processor 1020, memory 1030, input component 1040, output component 1050, and communication interface 1060. In another implementation, device 1000 may include additional, fewer, different, or differently arranged components.

Bus 1010 may include one or more communication paths that permit communication among the components of device 1000. Processor 1020 may include a processor, microprocessor, or processing logic that may interpret and execute instructions. In some embodiments, processor 1020 may be or may include one or more hardware processors. Memory 1030 may include any type of dynamic storage device that may store information and instructions for execution by processor 1020, and/or any type of non-volatile storage device that may store information for use by processor 1020.

Input component 1040 may include a mechanism that permits an operator to input information to device 1000 and/or other receives or detects input from a source external to 1040, such as a touchpad, a touchscreen, a keyboard, a keypad, a button, a switch, a microphone or other audio input component, etc. In some embodiments, input component 1040 may include, or may be communicatively coupled to, one or more sensors, such as a motion sensor (e.g., which may be or may include a gyroscope, accelerometer, or the like), a location sensor (e.g., a Global Positioning System (“GPS”)-based location sensor or some other suitable type of location sensor or location determination component), a thermometer, a barometer, and/or some other type of sensor. Output component 1050 may include a mechanism that outputs information to the operator, such as a display, a speaker, one or more light emitting diodes (“LEDs”), etc.

Communication interface 1060 may include any transceiver-like mechanism that enables device 1000 to communicate with other devices and/or systems. For example, communication interface 1060 may include an Ethernet interface, an optical interface, a coaxial interface, or the like. Communication interface 1060 may include a wireless communication device, such as an infrared (“IR”) receiver, a Bluetooth® radio, or the like. The wireless communication device may be coupled to an external device, such as a remote control, a wireless keyboard, a mobile telephone, etc. In some embodiments, device 1000 may include more than one communication interface 1060. For instance, device 1000 may include an optical interface and an Ethernet interface.

Device 1000 may perform certain operations relating to one or more processes described above. Device 1000 may perform these operations in response to processor 1020 executing software instructions stored in a computer-readable medium, such as memory 1030. A computer-readable medium may be defined as a non-transitory memory device. A memory device may include space within a single physical memory device or spread across multiple physical memory devices. The software instructions may be read into memory 1030 from another computer-readable medium or from another device. The software instructions stored in memory 1030 may cause processor 1020 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1-7), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A device, comprising:
one or more processors configured to:
identify one or more models that correlate one or more attributes associated with one or more orders to one or more order modification parameters;
receive an indication that a particular order has been placed;
place the particular order in an order queue that includes one or more other orders;
identify attributes of the particular order;
compare the attributes of the particular order to attributes included in the one or more models;
identify a particular set of order modification parameters, included in the one or more models, based on the comparing;
receive a modification to the particular order;
determine, based on the identified particular set of order modification parameters, a position in the order queue for the modified particular order; and
replace the particular order with the modified particular order, wherein replacing the particular order includes placing the modified particular order in the determined position in the order queue.

2. The device of claim 1, wherein placing the particular order in the order queue includes placing the particular order in a particular position of the order queue, and wherein replacing the particular order with the modified particular order includes placing the modified particular order at the same particular position of the order queue.

3. The device of claim 2, wherein the particular order is a first order, and wherein the one or more processors are further configured to:
identify a second order that is ahead of the modified first order in the order queue;
receive a modification to the second order; and
replace the second order with the modified second order, wherein replacing the second order includes placing the modified second order behind the modified first order in the order queue.

4. The device of claim 1, wherein the set of order modification parameters indicate whether the modified particular order should be placed in a different position in the order queue from the particular order.

5. The device of claim 1, wherein the attributes of the one or more orders include at least one of:
attributes of one or more User Equipment (“UEs”) from which the one or more orders were placed, or
attributes of one or more users associated with the one or more orders.

6. The device of claim 1, wherein the one or more processors are further configured to:
present one or more selectable order modification options to a User Equipment (“UE”) associated with the particular order,
wherein the one or more order modification options are selected from a plurality of order modification options based on the particular set of order modification parameters, and
wherein the modification to the particular order is received based on a selection, at the UE, of a particular selectable order modification option of the one or more selectable order modification options.

7. The device of claim 1, wherein the one or more processors are further configured to:
use one or more artificial intelligence/machine learning (“AI/ML”) techniques to identify correlations between:
particular sets of the one or more attributes associated with the one or more orders, and
particular order modification parameters of the one or more order modification parameters; and
generate or modify the one or more models based on the identified correlations.

8. A non-transitory computer-readable medium, storing a plurality of processor-executable instructions to:
identify one or more models that correlate one or more attributes associated with one or more orders to one or more order modification parameters;
receive an indication that a particular order has been placed;
place the particular order in an order queue that includes one or more other orders;
identify attributes of the particular order;
compare the attributes of the particular order to attributes included in the one or more models;
identify a particular set of order modification parameters, included in the one or more models, based on the comparing;
receive a modification to the particular order;
determine, based on the identified particular set of order modification parameters, a position in the order queue for the modified particular order; and
replace the particular order with the modified particular order, wherein replacing the particular order includes placing the modified particular order in the determined position in the order queue.

9. The non-transitory computer-readable medium of claim 8, wherein placing the particular order in the order queue includes placing the particular order in a particular position of the order queue, and wherein replacing the particular order with the modified particular order includes placing the modified particular order at the same particular position of the order queue.

10. The non-transitory computer-readable medium of claim 9, wherein the particular order is a first order, and wherein the plurality of processor-executable instructions further include processor-executable instructions to:
identify a second order that is ahead of the modified first order in the order queue;
receive a modification to the second order; and
replace the second order with the modified second order, wherein replacing the second order includes placing the modified second order behind the modified first order in the order queue.

11. The non-transitory computer-readable medium of claim 8, wherein the set of order modification parameters indicate whether the modified particular order should be placed in a different position in the order queue from the particular order.

12. The non-transitory computer-readable medium of claim 8, wherein the attributes of the one or more orders include at least one of:
attributes of one or more User Equipment (“UEs”) from which the one or more orders were placed, or
attributes of one or more users associated with the one or more orders.

13. The non-transitory computer-readable medium of claim 8, wherein the plurality of processor-executable instructions further include processor-executable instructions to:
present one or more selectable order modification options to a User Equipment (“UE”) associated with the particular order,
wherein the one or more order modification options are selected from a plurality of order modification options based on the particular set of order modification parameters, and
wherein the modification to the particular order is received based on a selection, at the UE, of a particular selectable order modification option of the one or more selectable order modification options.

14. The non-transitory computer-readable medium of claim 8, wherein the plurality of processor-executable instructions further include processor-executable instructions to:
use one or more artificial intelligence/machine learning (“AI/ML”) techniques to identify correlations between:
particular sets of the one or more attributes associated with the one or more orders, and
particular order modification parameters of the one or more order modification parameters; and
generate or modify the one or more models based on the identified correlations.

15. A method, comprising:
identifying one or more models that correlate one or more attributes associated with one or more orders to one or more order modification parameters;
receiving an indication that a particular order has been placed;
placing the particular order in an order queue that includes one or more other orders;
identifying attributes of the particular order;
comparing the attributes of the particular order to attributes included in the one or more models;
identifying a particular set of order modification parameters, included in the one or more models, based on the comparing;
receiving a modification to the particular order;
determining, based on the identified particular set of order modification parameters, a position in the order queue for the modified particular order; and
replacing the particular order with the modified particular order, wherein replacing the particular order includes placing the modified particular order in the determined position in the order queue.

16. The method of claim 15, wherein the particular order is a first order, wherein placing the first order in the order queue includes placing the first order in a particular position of the order queue, and wherein replacing the first order with the modified first order includes placing the modified first order at the same particular position of the order queue, wherein the method further comprises:
identifying a second order that is ahead of the modified first order in the order queue;
receiving a modification to the second order; and
replacing the second order with the modified second order, wherein replacing the second order includes placing the modified second order behind the modified first order in the order queue.

17. The method of claim 15, wherein the set of order modification parameters indicate whether the modified particular order should be placed in a different position in the order queue from the particular order.

18. The method of claim 15, wherein the attributes of the one or more orders include at least one of:
attributes of one or more User Equipment (“UEs”) from which the one or more orders were placed, or
attributes of one or more users associated with the one or more orders.

19. The method of claim 15, further comprising:
presenting one or more selectable order modification options to a User Equipment (“UE”) associated with the particular order,
wherein the one or more order modification options are selected from a plurality of order modification options based on the particular set of order modification parameters,
wherein the modification to the particular order is received based on a selection, at the UE, of a particular selectable order modification option of the one or more selectable order modification options,
wherein when the particular set of order modification parameters includes a first set of order modification parameters, the one or more order modification options include an option to modify the particular order and place the modified particular order in a same position in the order queue as a current position of the particular order, and
wherein when the particular set of order modification parameters includes a second set of order modification parameters, the one or more order modification options include an option to modify the particular order and place the modified particular order in a different position in the order queue from the current position of the particular order.

20. The method of claim 15, further comprising:
using one or more artificial intelligence/machine learning (“AI/ML”) techniques to identify correlations between:
particular sets of the one or more attributes associated with the one or more orders, and
particular order modification parameters of the one or more order modification parameters; and
generating or modifying the one or more models based on the identified correlations.
